(19) United States
(12) Patent Application Publication
(10) Pub. No.: US 2008/0059123 A1
(43) Pub. Date: Mar. 6, 2008

(54) MANAGEMENT OF HOST COMPLIANCE EVALUATION

(75) Inventors: Mark Estberg, Seattle, WA (US); John Howie, Seattle, WA (US); Man Nguyen, Kirkland, WA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 11/468,204

(22) Filed: Aug. 29, 2006

(51) Int. Cl. G06Q 10/00; G06F 19/00; G06F 17/40

(52) U.S. Cl. 702/188; 702/127; 702/182; 702/186; 340/500; 340/540; 705/1; 705/7; 705/11

(57) ABSTRACT

A compliance management system aligns data used to determine technical compliance of a computer system with business groups associated with the computer system. An operator may configure target compliance information, identify target computers to test for compliance, schedule compliance checks and manage ongoing compliance checks through a user interface. After receiving target compliance information and scheduling information, the compliance management system automatically scans the host systems for evidence, determines a state of compliance from the evidence, and may provide reports and other information to an operator. Once the compliance state for a business group is determined, compliance state information can be reported. Compliance state information can be provided in different formats based on the intended recipient of the report.

### BACKGROUND

Maintaining efficient, secure and up to date computing systems is important to any business. Businesses often employ policies and regulations to ensure their computing systems are maintained in an efficient manner. Technical compliance management (TCM) is a process for ensuring that one or more computing systems comply with policies and regulations for security, updates and other data. A TCM process involves identifying system assets, establishing asset ownership, defining requirements for the assets, and determining if the assets meet the requirements. System assets may be identified as data, computing devices, or people. Asset ownership is established in order to identify a person or entity to notify or hold accountable (department head or machine user) if an asset does not comply with asset requirements. Asset requirements can be defined through risk management for each asset category. For example, a computing device at risk of being accessed by unauthorized sources over a network should include firewall or other protection.

After defining baseline requirements, the computer system subject to the requirements is analyzed to determine if it meets the requirements. Analyzing the computer system may include manually detecting files that are required or missing from a computing device. Computing devices that do not comply with the requirements may be brought to compliance accordingly. In particular, non-complying machines may be corrected manually by upgrading software, installing missing software, and so on.

Two primary challenges face businesses when ensuring that host computers (such as desktop computers, laptop computers, servers, etc.) comply with internal policies and regulations; lack of compliance data and uncoordinated compliance data through TCM. Enterprises often lack visibility into the effectiveness of their information technology controls which are designed to meet their business objectives and regulatory needs. Some of the data retrieved in order perform TCM is not always reliable. Further, the data that does exist is often disconnected from policies, regulations and business and IT objectives. Thus, there is often a disconnect between the business objectives and the data collected by TCM.

### SUMMARY

The technology described herein pertains to a compliance management system that aligns compliance data to business objectives and performs TCM automatically. An operator may use the compliance management system to configure target compliance information, identify target computers to test for compliance against the target compliance information, and schedule compliance checks of the identified target computers. The target compliance information may associate business objectives to individual target computer data to be analyzed for compliance. Computer system compliance may be configured and monitored through a user interface provided by the compliance management system. The compliance management system automatically scans the host systems for evidence, determines a state of compliance from the evidence, and provides reports and other information to an operator.

Target compliance information is used to outline the technical compliance requirements to be met by target computers in a business group. In some embodiments, the target compliance information may be in the form of a data model. The data model may associate business groups and objectives to target computer data within a compliance hierarchy. Target computers are scanned for evidentiary data specified in the data model. Based on the evidentiary data found at each target computer, the compliance of the business group can be determined.

Compliance management can be configured through a user interface. The user interface may enable a user to generate target compliance information within a compliance group hierarchy, identify target computers to be tested for compliance, and schedule compliance checks for the target computers based on the target compliance information. Once the state of business group compliance is determined, compliance state information can be reported. Compliance state information can be provided in different formats based on the intended recipient of the report. In one embodiment, different levels of technical detail can be provided in different reports based on the recipient of the report.

In one embodiment, technical compliance may be determined for a computer by receiving target compliance information, generating a compliance check schedule and automatically determining the compliance of the computer based on the schedule and the target compliance information. The target compliance information can be received through an interface and include a business group and evidentiary data corresponding to the business group. The compliance check schedule may be associated with performing a compliance check on a target computer using the target compliance information.

In one embodiment, compliance for a computer is performed by identifying a business group to be analyzed for technical compliance, identifying a set of evidentiary data associated with the business group, scanning one or more computer targets to retrieve the set of evidentiary data, and determining technical compliance of the business group based on the retrieved evidentiary data.

This summary is provided to introduce a selection of concepts in a simplified form that are further described below in the description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of an embodiment of a system for determining technical compliance of computing systems.

FIG. 2 is an embodiment of a computing environment.

FIG. 3 is a flow chart of an embodiment of a process for determining technical compliance for one or more computing devices.

FIG. 4A is a flow chart of an embodiment of a process for configuring technical compliance information.

FIG. 4B is an example of a compliance data hierarchy.

FIG. 4C is an example of target compliance information in a compliance data hierarchy.

FIG. 5 is a flowchart of an embodiment of a process for configuring and storing target compliance information.

FIG. 6 is a flowchart of an embodiment of a process for specifying target computers to be scanned.

FIG. 7 is a flowchart of an embodiment of a process for associating target compliance information to target computers.

FIG. 8 is a flowchart of an embodiment of a process for scanning a target computer.

FIG. 9 is a flowchart of an embodiment for querying a target computer by a scan server.

FIG. 10A an example of a user interface for specifying target compliance information.

FIG. 10B is an example of a user interface for specifying target computers.

FIG. 10C is an example of a user interface for associating target compliance information with target computers to scan.

FIG. 10D is an example of a user interface for reporting scan progress and results.

FIG. 10E is another example of a user interface for reporting scan progress and results.

### DETAILED DESCRIPTION

A compliance management system aligns compliance data with business objectives and automatically performs TCM. An operator may use the compliance management system to configure target compliance information, identify target computers to test for compliance against the target compliance information, and schedule compliance checks of the identified target computers. The target compliance information may associate business objectives to individual target computer data to be analyzed for compliance. The compliance may be configured and monitored through a user interface provided by the compliance management system. The compliance management system automatically scans the host systems for evidence, determines a state of compliance from the evidence, and provides reports and other information to an operator.

Target compliance information is used to outline the technical compliance requirements to be met by target computers in a business group. In some embodiments, the target compliance information may be in the form of a data model. The data model may associate business groups and objectives to target computer data within a compliance hierarchy. Target computers are scanned for evidentiary data based on the data model. Compliance for a particular business group is determined based on the evidentiary data found at each target computer. After each target computer in a business group has been evaluated for compliance, the compliance of the business group can be determined.

Compliance management can be configured through a user interface. The user interface may enable a user to generate target compliance information within a compliance group hierarchy, identify target computers to be tested for compliance, and schedule compliance checks for the target computers based on the target compliance information. The interface may be in communication with and/or provided by a data store wherein the target compliance information is stored.

Once the state of business group compliance is determined, compliance state information can be reported. Compliance state information can be provided in different formats based on the intended recipient of the report. In one embodiment, different levels of technical detail can be provided in different reports. For example, a high level of technical detail can be reported to a system administrator while a low level of detail may be provided to a business executive.

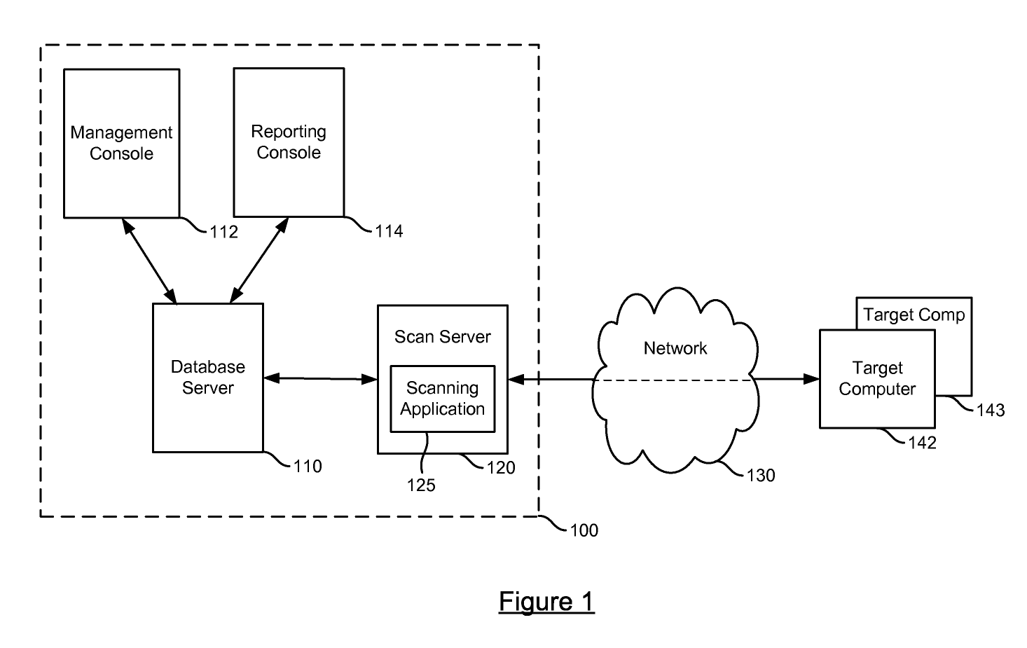

FIG. 1 is a block diagram of an embodiment of compliance management system 100. FIG. 1 includes compliance management system 100, network 130 and target computers 142 and 143. Compliance management system 100 is in communication with target computers 142 and 143 over network 130 and includes database server 110, scan server 120, management console 112 and reporting console 114. Network 130 may be implemented as a public network, private network, the Internet, an intranet, or some other network.

Database server 110 is in communication with management console 112, reporting console 114, and scan server 120. Data and information stored by database server 110 includes target compliance information, host data retrieved from a host machine scan, and other scan and compliance data, such as scheduling, target computer, and scan server data. Additionally, database server 110 may scan target machines 142-143. The scans may be initiated by generating scan instructions and sending the generated instructions to scan server 120. Scan data retrieved by scan server 120 is then received and stored by database server 110. In some embodiments, database server 110 may be implemented as an SQL server.

Management console 112 is in communication with database server 110 and may enable a user to configure target compliance information, target computer data, associate target compliance information to target computers and schedule and manage scans. In some embodiments, management consoles may enables a user to configure the compliance information, data and tasks through a user. In some embodiments, management console 112 may be implemented as a network browser application on a computing device in communication with database server 110 over a network such as network 130.

Reporting console 114 is in communication with database server 110 and may be used to report compliance results. The compliance results may be organized by recipient role, service level agreement (SLA), compliance success, or some other parameter. For example, a report for the technical compliance of host machines within a human resources business group may be provided with a low level of technical detail for a business executive. In some embodiments, reporting console 114 may be implemented as a network browser application on a computing device in communication with database server 110 over a network or on database server 110.

Scan server 120 is in communication with database server 110 and target computers 142-143. Scan server 120 may scan target computers 142-143 in response to receiving and executing scan instructions from database server 110. Scan data retrieved by scan server 120 from target computers 142-143 is provided to database server 110. In some embodiments, scan server 120 may include scanning application 125. Scanning application 125 may perform scanning functions, such as interpreting scan instructions, scanning target computers, processing scanned data and forwarding the scanned data to database server 110.

Target computers 142-143 may be implemented as any computer or machine within a business group to be checked for compliance. Examples of target computers include desktop machines used by employees of a company, servers providing an internal network for a company or other machines used in a business. Target computers 142-143 are in communication with scan server 120 over network 130.

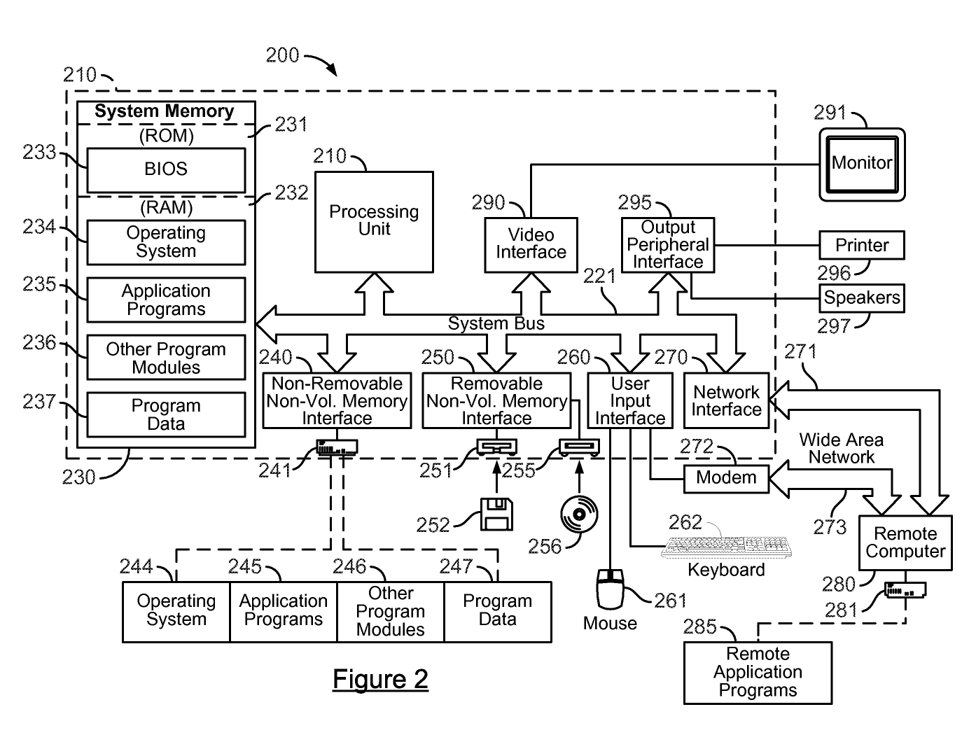

FIG. 2 is an embodiment of a computing environment. In some embodiments, the computing environment of FIG. 2 may be used to implement database server 110, scan server 120, target computers 142-143, and any computing devices used to implement management console 112 and reporting console 114.

FIG. 2 illustrates an embodiment of a computing environment 200 for implementing the present technology. In some embodiments, the computing environment of FIG. 2 may be used to implement database server 110, scan server 120, management console 112, reporting console 114, and target computers 142-143.

The computing system environment 200 is only one example of a suitable computing environment and is not intended to suggest any limitation as to the scope of use or functionality of the technology. Neither should the computing environment 200 be interpreted as having any dependency or requirement relating to any one or combination of components illustrated in the exemplary operating environment 200.

The technology is operational with numerous other general purpose or special purpose computing system environments or configurations. Examples of well known computing systems, environments, and/or configurations that may be suitable for use with the technology include, but are not limited to, personal computers, server computers, hand-held or laptop devices, cell phones, smart phones, multiprocessor systems, microprocessor-based systems, set top boxes, programmable consumer electronics, network PCs, minicomputers, mainframe computers, distributed computing environments that include any of the above systems or devices, and the like.

The technology may be described in the general context of computer-executable instructions, such as program modules, being executed by a computer. Generally, program modules include routines, programs, objects, components, data structures, etc. that perform particular tasks or implement particular abstract data types. The technology may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary system for implementing the technology includes a general purpose computing device in the form of a computer 210. Components of computer 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 2 illustrates operating system 234, application programs 235, other program modules 236, and program data 237.

The computer 210 may also include other removable/non-removable, volatile/nonvolatile computer storage media. By way of example only, FIG. 2 illustrates a hard disk drive 240 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 20 through input devices such as a keyboard 262 and pointing device 261, commonly referred to as a mouse, trackball or touch pad. Other input devices (not shown) may include a microphone, joystick, game pad, satellite dish, scanner, or the like. These and other input devices are often connected to the processing unit 220 through a user input interface 260 that is coupled to the system bus, but may be connected by other interface and bus structures, such as a parallel port, game port or a universal serial bus (USB). A monitor 291 or other type of display device is also connected to the system bus 221 via an interface, such as a video interface 290. In addition to the monitor, computers may also include other peripheral output devices such as speakers 297 and printer 296, which may be connected through an output peripheral interface 290.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. It will be appreciated that the network connections shown are exemplary and other means of establishing a communications link between the computers may be used.

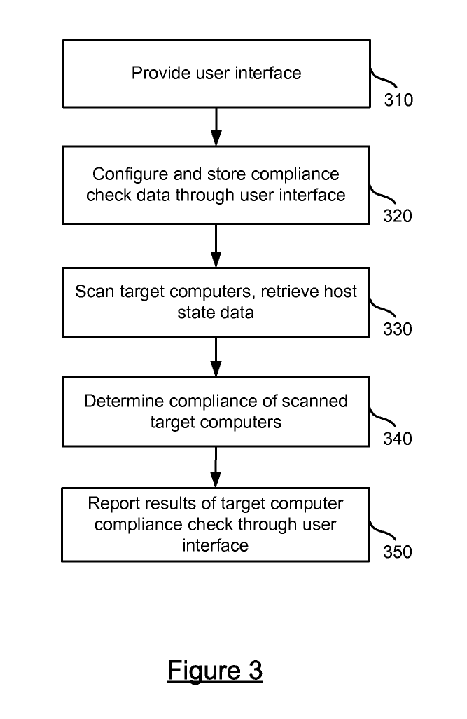

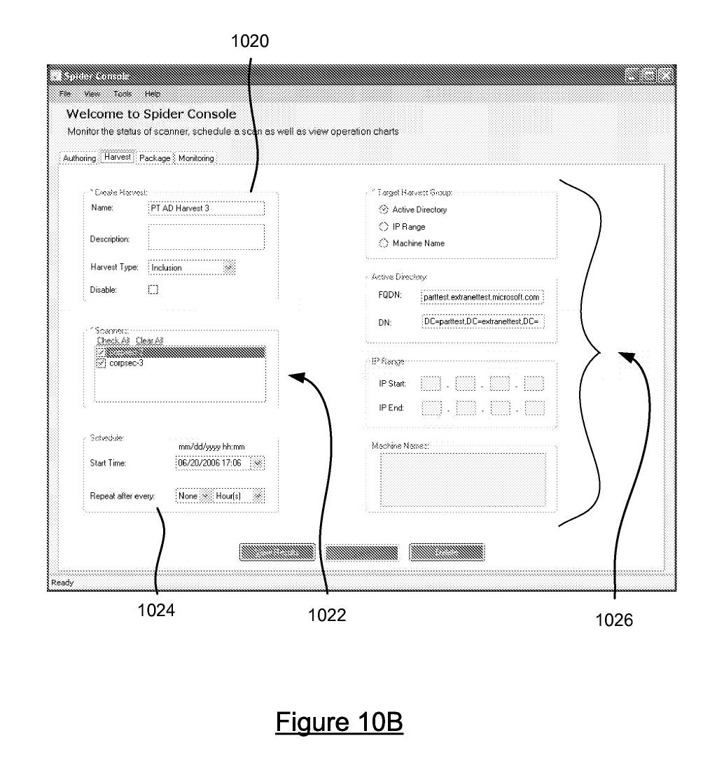

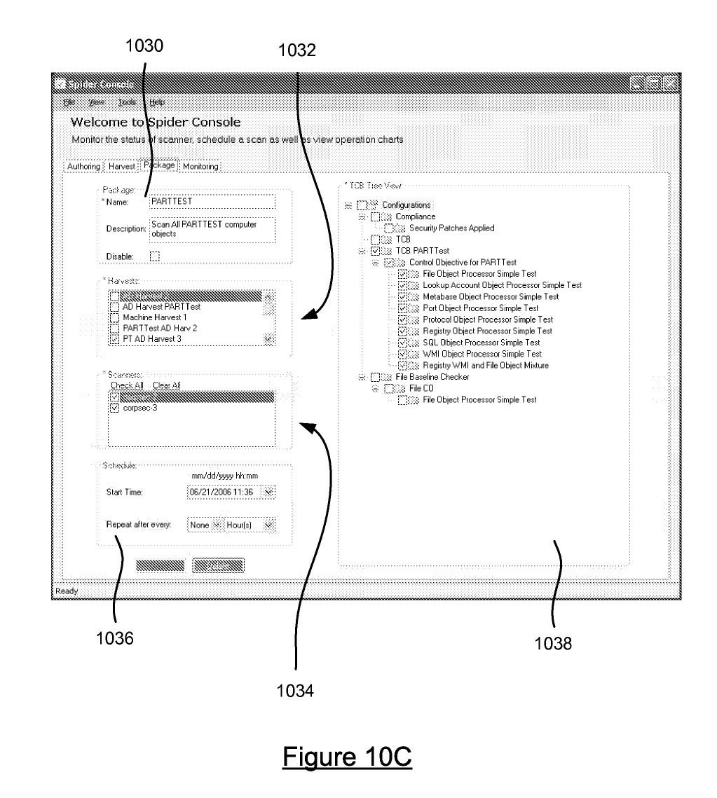

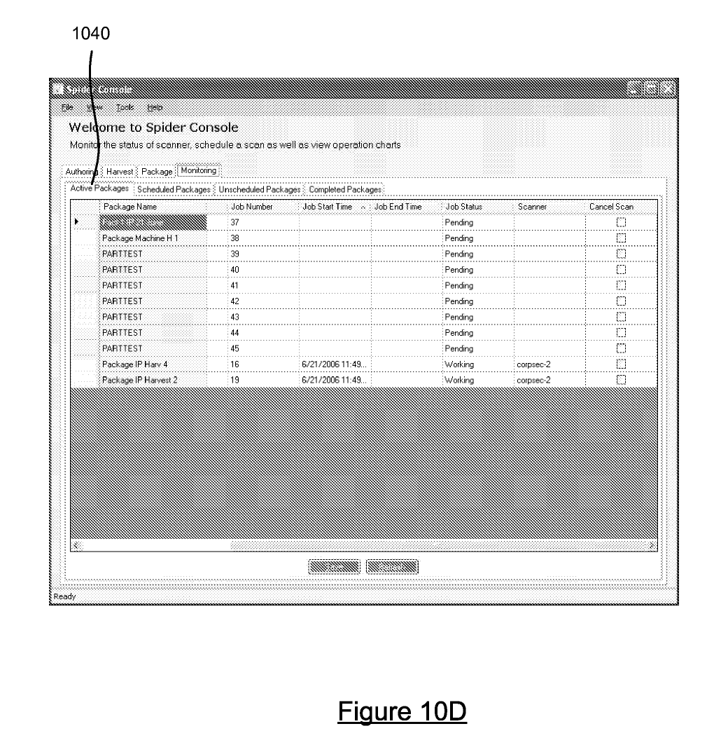

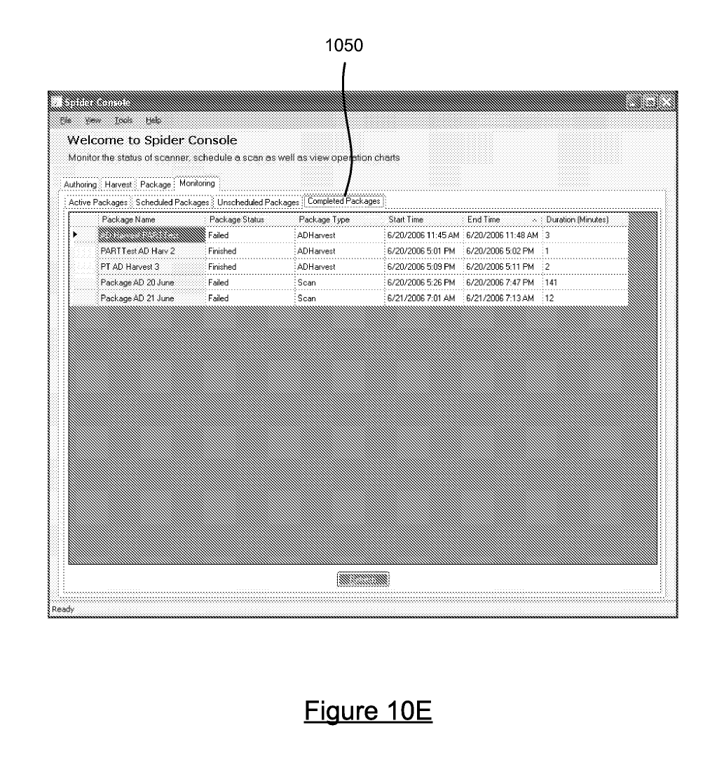

FIG. 3 is a flow chart of an embodiment of a process for determining technical compliance for one or more computing devices. In one embodiment, the process of FIG. 3 may be performed by compliance management system 100. A user interface is provided at step 310. The user interface may be provided by management console 112, for example through a browser application which implements management console 112. Examples of an interface provided by management console 112 are provided in FIGS. 10A-10E. The examples illustrated may be used to implement different phases of technical compliance management, such as creation of target compliance information in FIG. 10A, identification of target machines in FIG. 10B, association of target compliance information and target machines in FIG. 10C, and monitoring the scanning of and compliance of target machines in FIGS. 10D-E. FIGS. 10A-10E are discussed in more detail below.

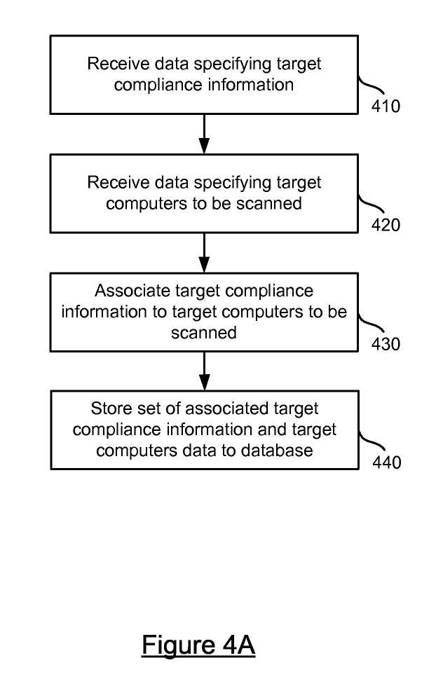

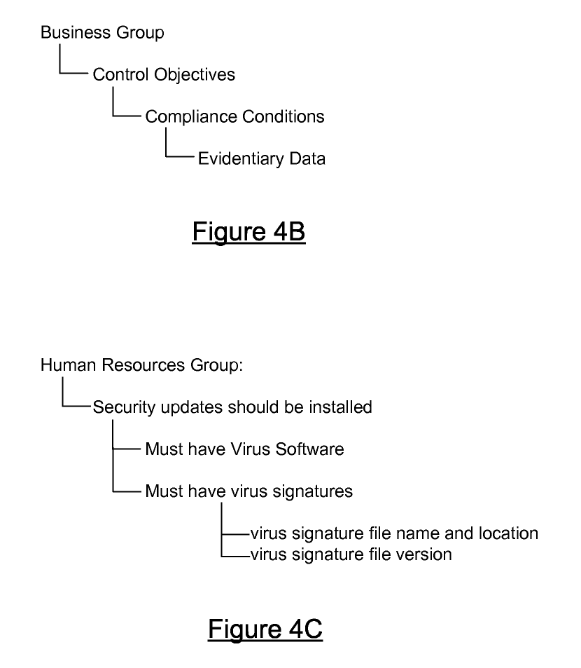

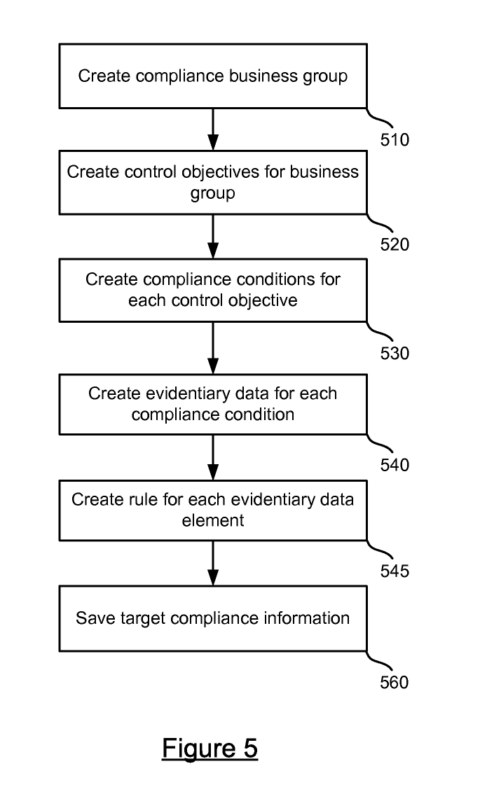

Target compliance information is configured through the user interface and stored at step 320. Configuring target compliance information may include specifying target computer information. The specified target compliance information is used to generate the parameters and instructions for performing a compliance check and target computers subject to the compliance check. Configuring target compliance information is discussed in more detail below with respect to the process of FIG. 4A.

In one embodiment, target compliance data may be organized within a compliance data hierarchy. The compliance data hierarchy may associate business groups and objectives to target computer evidentiary data. The evidentiary data may be gathered and processed to determine technical compliance of target computers associated with the business group.

FIG. 4B is an example of a compliance data hierarchy. The compliance data hierarchy has a root node of business group. A business group is a group of target computers that are associated in some way. For example, the business group may be human resources group, a sales group, or other group within a business. For each business group, three levels of sub-nodes may be defined. The first sub-node is control objectives. A control objective is a technical compliance objective to be met for target computers associated with a business group. For each control objective, a set of compliance conditions may be specified. The compliance conditions are required to be met in order to achieve the corresponding control objective. For each compliance condition, a set of evidentiary data may be specified. Evidentiary data is evidence which may be obtained or accessed to determine if the particular compliance condition is met. Thus, a compliance condition is met if a specified set of evidentiary data is obtained. If all compliance conditions for a control objective are met, the control objective is satisfied. If all control objectives for a business group are satisfied, then the business group is in compliance.

FIG. 4C is an example of target compliance information in a compliance data hierarchy. The data of FIG. 4C exists within the hierarchy in FIG. 4B. The business group root node of the hierarchy in FIG. 4C is a human resources group. The control objective sub-node associated with the human resource group is “security updates should be installed.” Thus, the control objective is related to maintaining the latest security updates in target machines associated with the human resources group.

The control objective sub-node has compliance condition sub-nodes of “having virus software” and “having virus signatures.” Thus, in order for the objective of “having security updates installed for the human resources group” to be satisfied, each computer in the human resources group must have acceptable virus software and a virus signature. The compliance condition of requiring virus signatures is met by retrieving evidentiary data of a “virus signature file name” and a “virus signature file version.” For each computer in the human resources group, the current virus signature file and signature file version is compared to a stored target virus signature file and virus signature file version. If the accessed files do not meet or exceed the stored target file data, the particular computer in the human resources group will not comply with this particular compliance condition and corresponding control objective.

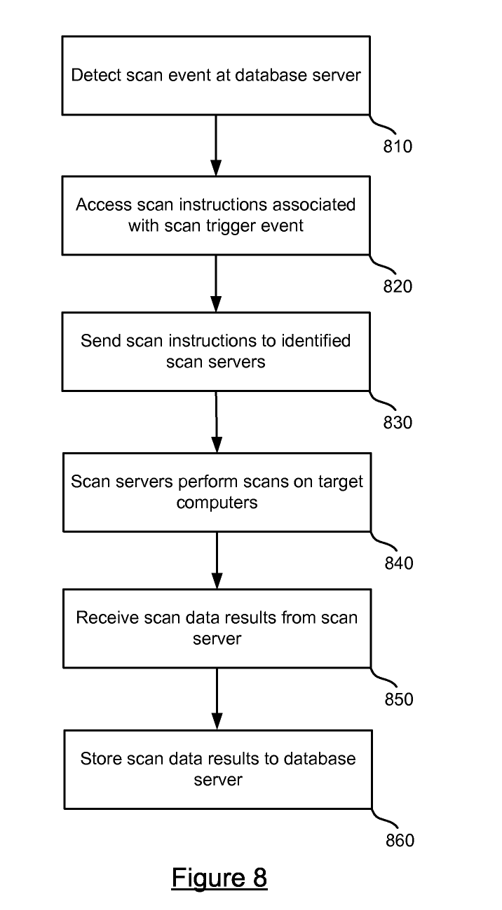

Returning to the process of FIG. 3, target computers are scanned in accordance with the target compliance information at step 330. In some embodiments, compliance management system 100 scans target computers 142-143 to retrieve host state data corresponding to the target compliance information. In particular, target computers 142-143 may be scanned for the evidentiary data of the target compliance information. The retrieved host state data is then stored in database server 110. The retrieved host state data may or may not match the evidentiary data of the target compliance information (for example, some desired evidentiary data may be missing from a target computer). Scanning of one or more target computers 142-143 is discussed in more detail below with respect to the process of FIG. 8.

The compliance of target computers scanned at step 330 is determined at step 340. Target computer compliance is determined by comparing the host state data retrieved at step 330 to the target compliance information configured at step 320. In particular, the host state data is compared to evidentiary data within the target compliance information for each compliance condition. If the evidentiary data within the target compliance information is met by the retrieved host data, then the particular compliance condition is met. If each compliance condition is met, and each corresponding control objective is met, then a particular target computer within a business group is determined to be in compliance.

For example, consider the target compliance information of FIG. 4C. The Human Resources business group has a control objective of “Security updates should be installed.” The control objective has compliance conditions “Must have Virus Software” and “Must have virus signatures”, the later of which is measured by evidentiary data of a virus signature file name and location and virus signature file version. The compliance condition of “Must have virus signatures” is met if the host state data retrieved matches an indicated virus signature file name, location and version. If the retrieved host state data does not match one of the required evidentiary data elements, then the corresponding condition “Must have virus signatures” is not met, and the corresponding control objective is not satisfied. If the retrieved host state data for a particular target computer matches all required evidentiary data for the two compliance conditions of FIG. 4C, then the control objective is met and the Human Resources group target computer is in compliance.

In some embodiments, the host state data retrieved from a target computer must match each evidentiary data element for a compliance condition to be met. In some embodiments, not every evidentiary data element need be found and satisfied in order for a corresponding compliance condition to be met. For example, a compliance condition may specify that any one of a number of files be contained on a target computer. In some embodiment, a business group may be in compliance if a certain percentage (for example, ninety-five percent) or a number or target machines less that the total number of machines are in compliance.

After determining compliance, the results of a compliance check are reported at step 470. Compliance check results may be reported through an interface provided by management console 112, in a report generated by reporting console 114, or in some other manner.

The reports provided by reporting console 114 may be tailored to a particular user. For example, reports for different users may contain a different level of technical detail. A report for an administrator may contain a high level of technical detail regarding compliance results, including the location of the target machines tested, the name and path of files accessed, the time the target machine was scanned, the scanner server and scanner application used to access the target machine, the response time of the scan, and other data.

A report for an administrator may have a level of technical detail that is less than that for an administrator. For example, compliance results provided for an administrator may indicate whether each compliance condition was met for each control objective. A report for a business executive may have a low level of technical detail. For instance, a compliance report for a business executive may indicate whether a business group passed or failed a compliance check. Information in the compliance reports may be color-coded. For example, for each compliance check in a business executive report, control objectives that were satisfied may be displayed in green while control objectives that were not satisfied may be displayed in red.

In some embodiments, scans can be monitored through either of management console 112 or reporting console 114 to determine the progress of a scan, whether the scan is complete, and other data. Reporting results and/or progress of a scan is discussed in more detail below with respect to the user interface examples provided in FIG. 10D and FIG. 10E.

FIG. 4A illustrates a process for configuring target compliance information. In one embodiment, the process of FIG. 4A provides more detail for step 320 of FIG. 3. Data which specifies target compliance information is received through an interface of management console 112 at step 410. The received target compliance information includes business groups, control objectives, compliance conditions and evidentiary data. This data is discussed above with respect to FIGS. 4B and 4C. Data is received for each node in the target compliance information hierarchy and saved to database server 110. Receiving and storing target compliance information is discussed below with respect to the process of FIG. 5. An interface for receiving target compliance information is provided in FIG. 10A and discussed in more detail below.

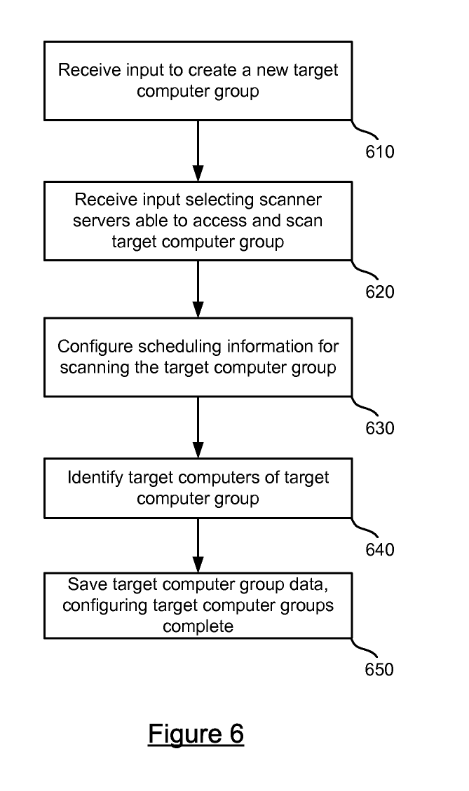

Data is received through management console 112 which specifies target computers to be scanned at step 420. The data received may indicate name for a group of computers, a location for the computers and other data. In some embodiments, scan servers in communication with the specified target computers may also be specified at step 420. Receiving data which specifies target computers to be scanned is discussed in more detail below with respect to FIG. 6. A user interface for specifying target computers to be scanned is provided in FIG. 10B and discussed in more detail below.

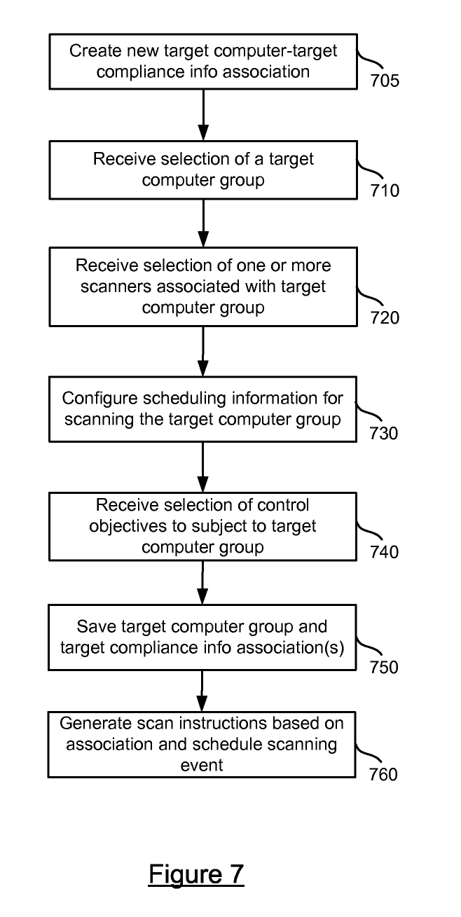

Target compliance information is associated with a group of target computers to be scanned at step 430. In this step, a group of target computers specified at step 420 are associated with a set of target compliance information specified at step 410 through management console 112. Associating target compliance information to a group of target computers is discussed in more detail below with respect to the process illustrated in FIG. 7. A user interface for associating the baseline group data to the target computers is provided in FIG. 10C and discussed in more detail below.

A set of associated target compliance information and target computers is stored to database server 110 at step 450. In one embodiment, data may be stored after each of steps 410-440. In any case, storing the associate target compliance information and target computer data may involve generating scan instructions and scheduling scan events. Scan instructions may be sent to a scan server upon the occurrence of a scan event. When received and executed by a scan server, the scan instructions cause the server to retrieve host state data from one or more specified target computers and provide the retrieved data to database server 110. A scan event may be set to trigger the transmittal of scan instructions to a scan server. In one embodiment, a scan event is scheduled in response to associating Target compliance information is associated with a group of target computers to be scanned at step 430, discussed in more detail below with respect to FIG. 7.

FIG. 5 is a flowchart of an embodiment of a process for configuring target compliance information. In one embodiment, the process of FIG. 5 provides more detail for step 410 in FIG. 4. Target compliance information may be configured through an interface provided by management console 112. An example of an interface for implementing the process of FIG. 5 is illustrated in FIG. 10A and referred to in the discussion below.

A compliance business group is created at step 510. In one embodiment, groups of target computers may be associated with one or more compliance business groups. Examples of business groups include human resources (as illustrated in the example target compliance information of FIG. 4C), sales, legal department, chief executive officer, or some other business group. With respect to the interface of FIG. 10A, business group may be entered in the hierarchy displayed in data window 1012. In one embodiment, a user may position a cursor to select a point in the hierarchy at which the business group should be entered and provide input to enter the business group data. An example of a business group in data window 1012 is “CO Template Node.”

Next, control objectives for a business group are created at step 520. In one embodiment, control objectives may be received through a user interface in the same manner that business group data is received. With respect to the interface of FIG. 10A, some of the control objectives for the business group “CO Template Node” are a “Vulnerability in Plug and Play” objective, “Microsoft Security Bulletin” objectives, “Certificate Object Processor Error Test” objective, and other objectives.

Compliance conditions for each control objective are then created at step 530 through the user interface. Compliance conditions may be received through a user interface in the same manner that business group data is received. With respect to the interface of FIG. 10A, four compliance conditions are listed for the control objective “Microsoft Security Bulletin MS05 047,” including a condition that begins as “Microsoft Security Bulletin MS05 047 WinXP.”

After creating compliance conditions for each control objective, an evidentiary data element is created for each compliance condition at step 540. Evidentiary data may be received through a user interface in the same manner that business group data is received. With respect to the interface of FIG. 10A, the compliance condition that begins with “Microsoft Security Bulletin MS05 047 WinXP” has an evidentiary file specified as MS05 047 WinXPSP2 Umpnpmgr Rule. The specified evidentiary file will be accessed for each target computer in the corresponding business group.

A rule may be generated for each evidentiary data element at step 545. The rule may indicate how the evidentiary data and retrieved host state data are to be compared or processed to determine compliance with the condition corresponding to the evidence. The rule may specify the name of a file or other evidentiary element, a function to perform (such as a “compare” to see if files are equivalent), and other data such as file properties to compare or other data (such as version number for file). For example, in the interface of FIG. 10A, data window 1014 is used to configure an evidentiary rule. The rule configured in data window 1014 indicates that a file name “MS05 047 WinXPSP2 Umpnpmgr Rule” should be compared to determine if the file version is 5.1.2600.2744. Other examples of rule functions may require that retrieved host state data is greater than, equal to, less than, more recent than, less recent than, and other comparing functions.

The created target compliance information is saved to database server 110 at step 550. In one embodiment, the target compliance information is saved in response to a user selection of the “save” button in the interface of FIG. 10A. After saving the target compliance information, the process of FIG. 5 ends.

FIG. 6 is a flowchart of an embodiment of a process for specifying target computers to be scanned. In one embodiment, the process of FIG. 6 provides more detail of step 420 of FIG. 4. The interface of FIG. 10B is an example of an interface for specifying target computers to be scanned, and will be referred to throughout the discussion of the process of FIG. 6.

Input is received to create a new target computer group at step 610. In one embodiment, creating a new target computer group includes receiving input by management console 112 which specifies a target group name. The new target computer group may be associated with a group of target computers within a business group or some other group of associated computers. With respect to FIG. 10B, a new target computer group may be entered into data window 1020. In particular, a user may enter a target computer group name, description, and an indication as to whether the new target computer group should be “disabled” or not included in scans. Thus, if a target computer group is disabled, no scans will be scheduled for the group of computers.

Next, input is received through management console 112 selecting the scan servers able to access and scan the new target computer group at step 620. In one embodiment, the scan servers may be selected from a list of scan servers that are in communication with database server 110. Scan servers in communication with database server 110 may send a periodic “heartbeat” signal or some other indication that the scan server is working properly. In some embodiments, each scan server may provide database server 110 with a list of target computers that the scan server is in communication with in addition to the heartbeat signal. The scan servers may be selected through data window 1022 of the example interface of FIG. 10B. In particular, a user may select a box next to each listed scan server in data window 1022 that should be used to scan the new target computer group.

Scheduling information for scanning the target computer group is configured at step 630. The scheduling information may indicate a time and date to start scanning the target computer group and a frequency at which to continue the scanning. The scheduling information may be entered into data window 1024 of the interface of FIG. 10B. Data window 1024 provides for a scan start time and parameters for repeating the scan. For example, data window 1024 illustrates an entered scan start time of Jun. 20, 2006 at 17:06. Scan parameters may provide for scanning to repeat at a selected number of seconds, minutes, hours, days, weeks, or some other period of time.

Target computers are selected to be included in the new target computer group at step 640. In some embodiments, a user may select a target computer in several ways, including the location of the computer using active directory, the IP range of the computer, and a machine name of the computer. For each machine identification method, a user may enter the appropriate data to identify a machine. This is illustrated in data window 1026 of the interface of FIG. 10B. For example, if a computer is to be selected based on active directory information, the FQDN address and DN information for the computer is listed. If one or more computers are to be identified using an IP range, the starting IP range and ending IP ranges are identified. If one or more machines are to be identified by machine name, the machine names are identified. In this case, the location of the machine may be stored in a database along with a machine name. When a user enters a machine name into data window 1026, the entered name will be compared to the list of names and corresponding machine locations to find a matching computer. A matching computer will be associated with the other information entered in the interface of FIG. 10B.

The generated target computer group data is saved at step 650. In one embodiment, the target computer group data is saved to database server 112 in response to receiving user input selecting a “save” button in the interface of FIG. 10B. After saving the target computer group data, the process of FIG. 6 ends.

FIG. 7 is a flowchart of an embodiment of a process for associating target compliance information to one or more target computers. In one embodiment, the process of FIG. 7 provides more detail for step 440 of FIG. 4. The interface of FIG. 10C is an example of an interface for associating target compliance information to one or more target computers, and will be referred to throughout the discussion of the process of FIG. 7.

First, a new target computer-target compliance information association is generated at step 705. The new association may include a name, a description, and in indication as to whether the target computer-target compliance information association should be enabled or not. With respect to the interface of FIG. 10C, a user may type the association name and description into data window 1030. For example, a name is entered as “PARTEST” and a description of “Scan All PARTEST computer objects” is illustrated in data window 1030. Additionally, a user may check a “disable” box within data window 1030. When the disable box is checked, the generated target computer-target compliance information association will not be enabled, and scan events for the association will not be scheduled at step 770 discussed below.

A selection of a target computer group is received at step 710. The selection may be made from one or more target computer groups saved at step 660 of the process of FIG. 6. With respect to the interface of FIG. 10C, the target computer group may be selected through data window 1032 of the interface of FIG. 10C. Data window 1032 lists the target computer groups generated along with a check box. A user may select a check box corresponding to a particular target computer group to select that group.

Next, a selection of one or more scanners may be received at step 720. In one embodiment, the one or more selectable scanners are associated with the target computer groups selected at step 710. Thus, once one or more target computers are selected at step 710, the scanners associated with the selected target computers are provided to a user. Scanners may be associated with one or more target computers at step 620 in the process of FIG. 6 discussed above. With respect to the interface of FIG. 10C, a user may select a scanner from a list of scanners provided in data window 1034 by checking a box corresponding to the particular scanner.

Scheduling information for scanning the target computer group by the selected scanner selected is configured at step 730. In one embodiment, the scheduling information may have a default value that matches the scheduling information configured at step 630 in the process of FIG. 6. With respect to the interface of FIG. 10C, data window 1036 includes boxes for entering scheduling information. The scheduling information may include a scan start time and parameters for repeating the scan. For example, the start time in data window 1036 is entered as Jun. 21, 2006 11:36, and no repeating parameters are listed.

Next, a selection of control objectives to subject to the target computer group is received at step 740. The control objectives selected may be a part of the target compliance information generated and stored through the process of FIG. 5. In some embodiments, the entire set of generated target compliance information is displayed in an interface and may be selected. For example, in the interface of FIG. 10C, data window 1038 provides an entire set of target compliance information. The target compliance information set illustrated includes hierarchy nodes of business group (TCB, TCB PARTTest), control objectives for the business groups, and compliance conditions for the control objectives. In data window 1038, the business group of “TCB PARTTest is selected, resulting in automatic selection of the control objectives and compliance conditions contained within that business group.

The target computer-target compliance information association is saved at step 650. In one embodiment, the target computer-target compliance information association is saved to database server 112 in response to receiving user input selecting a “save” button in the interface of FIG. 10C. After saving the target computer group data, the process of FIG. 7 ends.

Scan instructions are generated and scanning events are scheduled at step 770. The scan instructions are based on the target computer-target compliance information association, and instruct scan servers which machines to scan. For example, scan instructions may instruct a selected server to scan a particular target computer group for evidentiary data associated with a “TCB PARTTest” business group. An example of a set of scan instructions generated by database server 112 is below.

```
<?xml version=“1.0” encoding=“Windows-1252” ?>
- <IPRangeHarvestingConfiguration>
- <Configuration ConfigName=“IP Range Harvesting” ConfigVersion=“1.0.0.0”>
  <ObjectProcessor Name=“Group” Assembly=“BPA.Common.dll”
Class=“Microsoft.WindowsServerSystem.BestPracticesAnalyzer.Common.GroupObjectProcessor” />
  <ObjectProcessor Name=“Resolve” Assembly=“BPA.Common.dll”
Class=“Microsoft.WindowsServerSystem.BestPracticesAnalyzer.Common.ResolveObjectProcessor” />
  <ObjectProcessor Name=“If” Assembly=“BPA.Common.dll”
Class=“Microsoft.WindowsServerSystem.BestPracticesAnalyzer.Common.IfObjectProcessor” />
  <ObjectProcessor Name=“Port” Assembly=“BPA.NetworkCollector.dll”
Class=“Microsoft.WindowsServerSystem.BestPracticesAnalyzer.Extensions.PortObjectProcessor” />
  <ObjectProcessor Name=“Enumerator” Assembly=“BPA.Common.dll”
Class=“Microsoft.WindowsServerSystem.BestPracticesAnalyzer.Common.EnumeratorObjectProcessor” />
  </Configuration>
- <Object Type=“Group” Name=“TargetGroupID”>
- <Object Type=“Enumerator” Key1=“10” Key2=“10” Key3=“1” Async=“0”>
  <Setting Key1=“IP1” Substitution=“IP1” />
- <Object Type=“Group” Name=“%IP1%.?.?.?”>
- <Object Type=“Enumerator” Key1=“70” Key2=“70” Key3=“1” Async=“0”>
  <Setting Key1=“IP2” Substitution=“IP2” />
- <Object Type=“Group” Name=“%IP1%.%IP2%.?.?”>
- <Object Type=“Enumerator” Key1=“31” Key2=“31” Key3=“1” Async=“0”>
  <Setting Key1=“IP3” Substitution=“IP3” />
- <Object Type=“Group” Name=“%IP1%.%IP2%.%IP3%.?”>
- <Object Type=“Enumerator” Key1=“0” Key2=“255” Key3=“1” Async=“0”>
  <Setting Key1=“IP4” Substitution=“IP4” />
- <Object Type=“Group” Name=“%IP1%.%IP2%.%IP3%.%IP4%”>
- <Object Name=“DCE endpoint resolution” Type=“Port”
Key1=“%IP1%.%IP2%.%IP3%.%IP4%” Timeout=“1” Async=“0”>
  <Setting Key1=“135” Key2=“TCP” Substitution=“Port135Available” />
- <Object Type=“If” Key1=“contains(‘%Port135Available%’,‘135 Available’)”>
- <Object Name=“Target Name” Type=“Resolve”
Key1=“%IP1%.%IP2%.%IP3%.%IP4%” Async=“0”>
  <Setting Key1=“TargetName” />
  </Object>
  </Object>
- <Object Type=“If” Key1=“contains(‘%Port135Available%’,‘135 Not Available’)”>
- <Object Name=“NETBIOS Session Service” Type=“Port”
Key1=“%IP1%.%IP2%.%IP3%.%IP4%” Timeout=“1” Async=“0”>
  <Setting Key1=“139” Key2=“TCP” Substitution=“Port139Available” />
- <Object Type=“If” Key1=“contains(‘%Port139Available%’,‘139 Available’)”>
- <Object Name=“Target Name” Type=“Resolve”
Key1=“%IP1%.%IP2%.%IP3%.%IP4%” Async=“0”>
  <Setting Key1=“TargetName” />
  </Object>
  </Object>
- <Object Type=“If” Key1=“contains(‘%Port139Available%’,‘139 Not Available’)”>
- <Object Name=“Microsoft data service” Type=“Port”
Key1=“%IP1%.%IP2%.%IP3%.%IP4%” Timeout=“1” Async=“0”>
  <Setting Key1=“445” Key2=“TCP” Substitution=“Port445Available” />
- <Object Type=“If” Key1=“contains(‘%Port139Available%’,‘139 Available’)”>
- <Object Name=“Target Name” Type=“Resolve”
Key1=“%IP1%.%IP2%.%IP3%.%IP4%” Async=“0”>
  <Setting Key1=“TargetName” />
  </Object>
  </Object>
  </Object>
  </Object>
  </Object>
  </Object>
  </Object>
  </Object>
  </Object>
  </Object>
  </Object>
  </Object>
  </Object>
  </Object>
  </Object>
  </Object>
  </IPRangeHarvestingConfiguration>
```

The example scan instructions are used with Microsoft's “Best Practices Analyzer”, and define object processors which may be used to collect data from files on an active directory server. In particular, the object processors are first defined with respect to object type name, assembly and class. The defined object processors are then called to find certain files within a target computer.

The scan events are scheduled at step 770 by database server 112 according to the scheduling information configured at step 730. When database server 112 detects the occurrence of a scan event, database server 112 sends the corresponding scan instructions to the corresponding one or more scan servers. The generated scan instructions are sent to a scan server some time before the target computers are actually scheduled to be scanned. For example, the scan instructions may be sent to a scan server five minutes before a target computer is to execute the scan instructions and scan a target computer.

FIG. 8 is a flowchart of an embodiment of a process for scanning target computers. In one embodiment, the process of FIG. 8 provides more detail for step 330 of FIG. 3. First, a scan event is detected at database server 110 at step 810. The scan event is scheduled at step 770 of the process of FIG. 7. The scan event indicates that a set of scan instructions should be sent to one or more scan servers. The scan event may be communicated internally to an event queue within database server 110.

Scan instructions associated with the detected scan event are accessed at step 820. The instructions accessed may be those stored at step 760 of FIG. 7 and are accessed from database server 110. Next, the accessed instructions are sent to scan server 120 by database server 110 at step 830. Database server 110 may send the instructions to the scan server selected at step 720 in the process of FIG. 7.

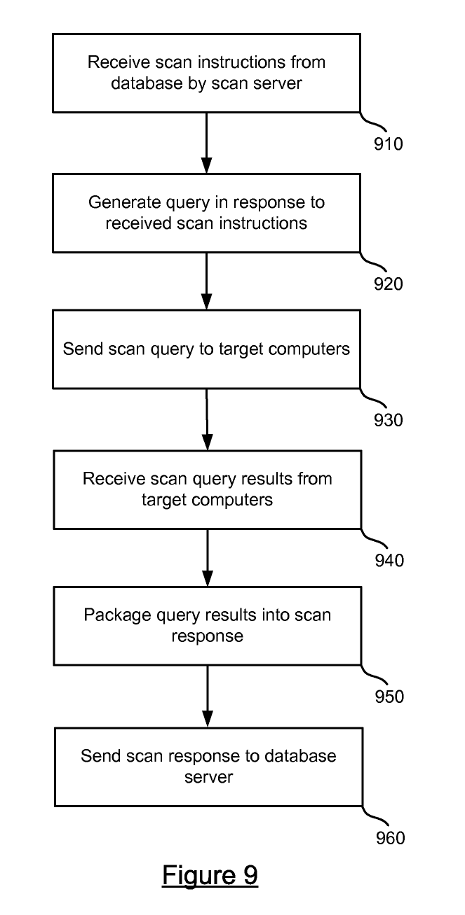

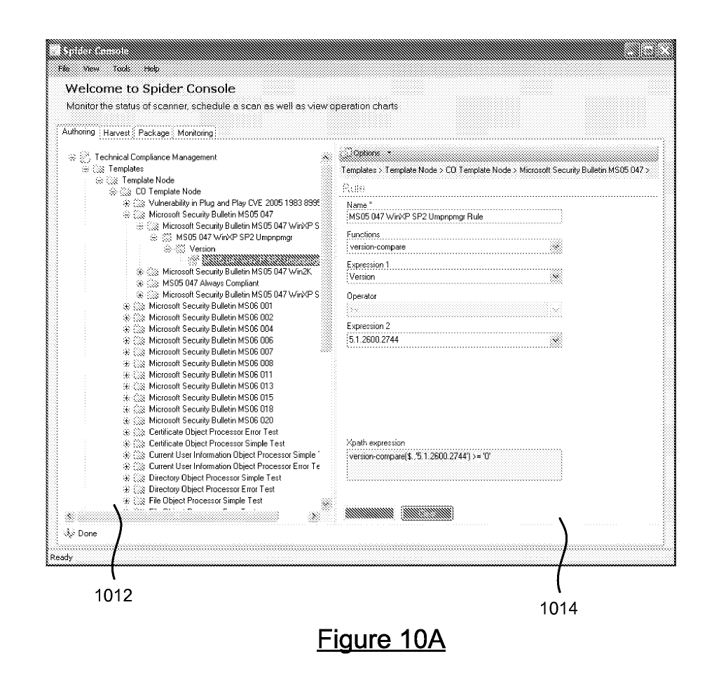

Scan server 120 performs a scan of one or more target computers 142-143 at step 840. Scan server 120 performs the scan on the target computers in response to the instructions received by scan server 120 from database server 110 at step 830. Performing a scan on target computers 142-143 by scan server 120 may include generating a query from the scan instructions, sending the query to the target computers, receiving a response from the target computers and providing response data to database server 110. Performing a scan of a target computer is discussed in more detail below with respect to the process of FIG. 9.

Database server 110 receives a scan response from scan server 120 at step 850. The scan response may include instances of evidentiary data which can be analyzed to determine if a compliance condition is met. The received scan response is stored to database server 110 at step 860.

FIG. 9 is a flowchart of an embodiment for scanning one or more target computers 142-143 by scan server 120. In one embodiment, the process of FIG. 9 provides more detail for step 840 of FIG. 8. First, scan instructions are received by scan server 120 from database 110 at step 910. The received scan instructions may be the same as those accessed at step 820.

A query is generated in response to the received scan instructions received at step 920. In particular, execution of the scan instructions received by scan server 1230 may cause scan server 120 to generate the query. The scan instructions may indicate the target machines to query and the files and other information to retrieve as evidentiary data. Scanning application 125 may be implemented as an application able to retrieve data from one or more target computers. In some embodiments, scanning application 125 may be implemented as “Best Practice Analyzer” software (BPA), by Microsoft Corporation, of Redmond, Wash. The BPA may enable querying of target computers having files organized in active directory systems.

Scan server 120 sends the generated query to target computers 142-143 at step 930. The query may be sent over network 130. When one or more of target computers 142-143 receive the query, each machine retrieves data as requested by the query. For example, target computers 142 may be requested to provide a virus protection program name, version, and date and a virus signature file name, version and date, as well as other data requested in the query. In this case, the target computer will access each file, determine the corresponding information for each file and send the requested information to scan server 120 as scan query results. If the requested file can not be found at the target computer, an indication is provided in the query results that the requested information is not available.

Scan server 120 receives the scan query results from target computers 142-143 at step 940. The scan query results may indicate the existence or non-existence of evidentiary data contained on the target computers. Scan server 120 packages the query results received from target computers into a scan response at step 950. The scan response is then sent to database server 110 at step 960. After receiving the scan response, database server 110 stores the scan response. An operator may then view reports and other information regarding the scan results.

FIGS. 10D and 10E illustrate examples of a user interface for reporting scan progress and results. The interface of FIG. 10D illustrates monitoring details for a set of target computer scans that are active. Active scans are those that have started but have not yet completed. Data window 1040 of the interface of FIG. 10D provides columns of package name, job number, job start time, job end time, job status, scanner and a box for cancelling a scan. The “package name” is a name associated with a target computer group-target compliance information association as discussed above with respect to the process of FIG. 7. A job number is an identifier assigned to the package name once the scan has been scheduled. The job start time and end time indicate the actual time that scan instructions were sent to a scan server (job start time) and the time that a scan response was received from the scan server (job end time). Job status indicates whether the scan is pending (scheduled buy not started yet), working (scheduled and started), or has another status level. The scan server performing the scan may be listed under the column “scanner.”

FIG. 10E illustrates monitoring details for a set of target computer scans that are completed. Data window 1050 of the interface of FIG. 10E includes columns of package name, package status, package type, start time and end time and duration. Package name is the same as that in the interface of FIG. 10D. Package status indicates whether the scan has finished successfully or failed. If the scan is not completed or can not be performed for some other reason, the scan has a status of “failed.” If the scan is completed, the scan status is “Finished.” The start time and end time indicate the times at which the scan instructions were sent to scan server 120 and the time at which a scan response was received from scan server 120 in response to the scan instructions. The duration is the time that elapsed between the start time and the stop time.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A method for determining technical compliance of a computer, comprising:
receiving target compliance information through an interface, the target compliance information including identification information for a business group and evidentiary data corresponding to the business group;
generating a compliance check schedule from user input received through the interface, the compliance check schedule associated with performing a compliance check on a target computer using the target compliance information; and
automatically determining the compliance of the target computer based on the compliance check schedule and the target compliance information.

2. The method of claim 1, wherein said step of receiving target compliance information includes:
receiving compliance condition information, the evidentiary data associated with one or more compliance conditions.

3. The method of claim 1, said step of receiving target compliance information includes:
receiving target compliance information in the form of a hierarchy.

4. The method of claim 1, further comprising:
identifying a target computer, the compliance check to be performed on the target computer.

5. The method of claim 4, wherein said step of identifying a target computer includes:
identifying a location of a target computer using a server active directory.

6. The method of claim 4, wherein said step of identifying a target computer includes:
identifying a location of a target computer using an internet protocol address.

7. The method of claim 1, wherein said step of generating a compliance check schedule includes:
identifying a scan server in communication with the target computer, the compliance check to be performed through the scan server.

8. The method of claim 1, wherein said step of generating a compliance check schedule includes:
configuring scan instructions to a scan server based on the compliance check schedule.

9. The method of claim 1, wherein the target compliance information further includes a control objective associated with the business group and a compliance condition associated with the control objective, the evidentiary data associated with the compliance condition.

10. One or more processor readable storage devices having processor readable code embodied on said processor readable storage devices, said processor readable code for programming one or more processors to perform a method comprising:
identifying a business group to be analyzed for technical compliance;
identifying a set of evidentiary data associated with the business group;
scanning one or more computer targets to retrieve the set of evidentiary data;
determining technical compliance of the business group based on the retrieved evidentiary data.

11. The one or more processor readable storage devices according to claim 10, the method further comprising:
providing an interface, wherein the business group and set of evidentiary data is received through the interface.

12. The one or more processor readable storage devices according to claim 10, wherein said step of scanning one or more computer targets includes:
identifying a scan server in communication with the one or more target computers scheduling a scan of the one or more target computers by the scan server.

13. The one or more processor readable storage devices according to claim 10, wherein said step of scanning one or more computer targets includes:
sending instructions to the scan server to scan the one or more target computers.

14. The one or more processor readable storage devices according to claim 13 wherein the scan instructions identify one or more files to locate on the one or more target computers.

15. The one or more processor readable storage devices according to claim 10, wherein said step of determining technical compliance includes:
comparing the retrieved set of evidentiary data to the identified set of evidentiary data.

16. The one or more processor readable storage devices according to claim 10, wherein said step of determining technical compliance includes:
determining whether the identified set of evidentiary data is located on the one or more target computers

17. The one or more processor readable storage devices according to claim 10, the method further comprising:
reporting the technical compliance of the business group.

18. An apparatus for processing data, comprising:
a communication interface;
a storage device; and
one or more processors in communication with said storage device and said communication interface, said one or more processors perform a method comprising,
receiving target evidentiary data through a user interface, the target evidentiary data corresponding to the business group,
receiving scheduling data through the user interface, the scheduling data associated with performing a compliance check on a target computer,
retrieving host state data based on the scheduling data,
comparing the target evidentiary data to the host state data to determine the compliance state of the business group, and
reporting the compliance state of the business group.

19. The apparatus of claim 18, wherein said step of reporting includes:
determining a recipient of a compliance state report; and
customizing the compliance state report based on the recipient.

20. The apparatus of claim 18, wherein said step of retrieving host state data includes:
generating instructions to retrieve host state data; and
sending the instructions to a scan server.
